(19) United States
(12) Patent Application Publication
(10) Pub. No.: US 2007/0220557 A1
(43) Pub. Date: Sep. 20, 2007

(54) Apparatus and method for reducing channel switching time in receiver for digital multimedia broadcasting system using conditional access system

(75) Inventors: Jae-Young Lee, Seoul (KR); Dae-Sop Park, Suwon-si (KR); Kyung-Eun Lee, Suwon-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/701,244

(22) Filed: Feb. 1, 2007

(30) Foreign Application Priority Data
Feb. 1, 2006 (KR) 9873-2006

(51) Int. Cl. H04N 7/173; G06F 13/00; H04N 5/445; H04N 7/167; G06F 3/00

(52) U.S. Cl. 725/54; 725/118; 725/31

(57) ABSTRACT

Disclosed are an apparatus and a method for reducing channel switching time in a receiver where a user uses Conditional Access System (CAS) information when he/she intends to receive a pay broadcast service in a Digital Multimedia Broadcast (DMB) system. The method includes parsing a searched Program Map Table (PMT) and extracting descriptor information of a corresponding broadcast channel; storing the descriptor information extracted for each broadcast channel in a memory; accessing the memory to forward the descriptor information of a corresponding broadcast channel to a CAS library when a user selects the corresponding broadcast channel; and generating a Control Word (CW) value for descrambling broadcast data by using the descriptor information.

### PRIORITY

This application claims priority under 35 U.S.C. § 119(a) of an application entitled “Apparatus and Method for Reducing Channel Switching Time in Receiver for Digital Multimedia Broadcasting System Using Conditional Access System” filed in the Korean Industrial Property Office on Feb. 1, 2006 and assigned Serial No. 2006-009873, the contents of which are incorporated herein by reference.

### BACKGROUND OF THE INVENTION

1. Field of the Invention

The present invention relates to an apparatus and a method for receiving Digital Multimedia Broadcasting (hereafter DMB) services, and more particularly to an apparatus and a method for receiving DMB services, in which a user uses Conditional Access System (hereafter CAS) information when he/she intends to receive a pay broadcast service in a DMB system.

2. Description of the Related Art

In general, digital broadcasting refers to a system which substitutes conventional analog broadcasting by providing users with high-quality services having high video quality and high quality audio of Compact Disc (CD) level. Such digital broadcasting has now evolved into two types of service: terrestrial broadcasting service and a satellite broadcasting service. Terrestrial broadcasting service refers to a broadcasting type in which broadcast data is transmitted through terrestrial repeaters, and satellite broadcasting service refers to a broadcasting type in which broadcast data is transmitted through satellite and/or terrestrial repeaters.

The terrestrial/satellite broadcasting service employs two schemes for providing high video and audio quality services. That is, a broadcast traffic is compressed with MPEG-2 (Moving Picture Experts Group-2) or MPEG-4 (Moving Picture Experts Group-4), having high compression rate, and then transmitted. This is because both schemes can compress a broadcast traffic, which has a large amount of information and requires high-speed transmission, at a high compression rate.

There are various schemes for providing digital broadcast services, such as DMB, Digital Audio Broadcasting (DAB), Digital Video Broadcasting-Handheld (DVB-H) and so forth. Above all, reference will now be made to a satellite DMB system, which employs the DMB scheme and partially provides pay broadcast services by using CAS information. First, in the specification of a receiver for the DMB satellite system, the receiver is required to have a terminal structure in which a plurality of channels can be received in order to receive one broadcast service.

A plurality of channels necessary for receiving one broadcast service in a receiver for a common DMB satellite system may include, for example, five channels of which one channel is for transmitting CAS information, one channel for transmitting EPG (Electronic Program Guide), two channels for transmitting a broadcast traffic, and a channel for transmitting pilot information. This is due to the fact that one broadcast service traffic consists of two channels in a DMB system.

Unlike a common terrestrial broadcasting system transmitting broadcast services to many and unspecified customers, the DMB satellite system, in which the above-mentioned CAS information is transmitted, transmits broadcast programs to service subscribers only, and must block unauthorized users from viewing programs. Thus, transmission/reception of CAS information used for that purpose is very important. CAS in combination with a subscriber management system is a core system for pay services of digital broadcasting, and enables subscribers to be accurately and conveniently provided with their desired services.

Further, viewed from the standpoint of a broadcast provider, CAS can prevent illegal viewing and provide broadcast services with priority given to viewers by providing various marketing materials such as subscriber's viewing trend, etc. A receiver for the DMB satellite system is provided with software and a smart card in which CAS is implemented, and communication between the software and the smart card is encrypted. The software in which CAS is implemented forwards a message for managing the viewing entitlement of a user, that is, an EMM (Entitlement management Message)/ECM (Entitlement Control Message), to the smart card, and then carries out an interoperation with the smart card to thereby generate a Control Word (hereafter CW) value for descrambling. The software forwards the generated CW value to a descrambler.

In other words, in order to receive a pay broadcast service in the DMB satellite system, a scrambled transmitted signal must be descrambled as mentioned above. A CW, which has been used in scrambling, is necessary for descrambling, and the CW can be acquired from data of the EMM/EMC. A variety of system information used for receiving a common satellite DMB service is allocated, for example, as presented in Table 1, which shows the configuration of a CDM (Code Division Multiplexing) channel.

TABLE 1

| CDM #0 | Pilot Data |
|---|---|
| CDM # 1 | PAT(0x0000), CAT(0x0001), NIT(0x0010), |
| | EMM(0x0030) |
| CDM #2 | EIT(0x0012), SDT(0x0011), TOT(0x0014), |
| | BIT(0x0024), PMT[music](0x0080˜0x0098) |
| CDM #3/4 | PMT(0x300), ECM(0x310), video PID(0x330), |
| | audio PID(0x350) |
| CDM #5/6 | PMT(0x500), ECM(0x510), video PID(0x530), |
| | audio PID(0x550) |
| CDM #7/8 | PMT(0x700), ECM(0x710), video PID(0x730), |
| | audio PID(0x750) |
| . . . | . . . |
| CDM #(n − 1)/n | PMT(0xm00), ECM(0xm10), video PID(0xm30); |
| | audio PID(0xm50) |

Referring to Table 1, it can be noted that PAT (Program Association Table), CAT (Conditional Access Table) and EMM can be received over CDM channel #1, and a PMT (Program Map Table) and an ECM of a corresponding program can be received over each of CDM channels #3/4 to #(n−1)/n.

Since a transmission stream, which carries a broadcast traffic in the DMB satellite system, can transmit a plurality of broadcast channels, relations between the broadcast channels included in the transmission stream and broadcast program elements constituting the broadcast channels, such as video data or audio data, must be defined. These relations are defined in the form of a table including PSI (Program Specification Information), and PSI consists of 4 types of tables including PAT, PMT and others. Packet Identifications (PID) of video, audio, text data packets included in a corresponding program are described in the PMT.

Meanwhile, in order to generate a CW necessary for descrambling broadcast data as stated above, reception of the PSI must be preceded, and each packet corresponding to the PSI has its own transmission cycle. Table 2 shows a transmission cycle at which each of PAT, CAT, NIT (Network Information Table), EMM, PMT and ECM is transmitted through each packet corresponding to the PSI.

TABLE 2

| | |
|---|---|
| PAT | 0.5 sec |
| CAT | 1 sec |
| NIT | 1 sec |
| EMM | P-Key (key refresh message): 10 sec |
| PMT | long period: 1 sec (audio), short period: 0.5 sec (video) |
| ECM | 0.5 sec |

Referring to Table 2, PMT and ECM have a transmission cycle of 500 ms (0.5 sec), respectively (based on DMB satellite). This means that it may take a receiver 0 to 1 second to receive the PMT and the ECM.

FIG. 1 illustrates channel switching time in a receiver for a conventional DMB satellite system.

Referring to FIG. 1, after a user's channel selection is done in step 101, it takes 0.5 second to search for a PMT in step 103, and then it takes 0.5 second to actually carry out descrambling in steps 105 to 109. Actually, the time required for PMT parsing and corresponding descriptor extraction is negligibly small, and a total time of 0.5 second required for carrying out descrambling is mostly occupied by the time required for searching for an ECM. When a user switched a channel to another channel, it takes a receiver 1 second to receive the PMT and extract an ECM for a channel, to which the current channel is switched in order to generate a CW. Thus, in the worst case, channel switching may be delayed up to 1 second or more.

### SUMMARY OF THE INVENTION

Accordingly, the present invention has been made to solve the above-mentioned problems occurring in the prior art, and an aspect of the present invention is to provide an apparatus and a method for reducing channel switching time when a user intends to receive a pay broadcast service in a DMB system.

In order to accomplish this aspect, in accordance with an aspect of the present invention, there is provided an apparatus for reducing channel switching time in a receiver device for a DMB system, the apparatus includes a PMT parser for parsing a searched PMT and extracting descriptor information of a corresponding broadcast channel; a memory for storing the descriptor information according to each broadcast channel; a CAS library for generating a CW value for descrambling by using the descriptor information; and a controller for storing the descriptor information extracted for each broadcast channel in the memory, and accessing the memory to forward the descriptor information of a corresponding broadcast channel to the CAS library when a user selects the corresponding broadcast channel.

In accordance with another aspect of the present invention, there is provided a method for reducing channel switching time in a receiver device for a DMB system, the method includes parsing a searched PMT and extracting descriptor information of a corresponding broadcast channel; storing the descriptor information extracted for each broadcast channel in memory; accessing the memory to forward the descriptor information of a corresponding broadcast channel to a CAS library when a user selects the corresponding broadcast channel; and generating a CW value for descrambling the broadcast data by using the descriptor information.

### BRIEF DESCRIPTION OF THE DRAWINGS

The above and other aspects, features and advantages of the present invention will be more apparent from the following detailed description taken in conjunction with the accompanying drawings, in which:

FIG. 1 illustrates channel switching time in a receiver for a conventional DMB satellite system;

FIG. 2 is a block diagram illustrating the structure of an apparatus for reducing channel switching time in a receiver for a DMB satellite system in accordance with a preferred embodiment of the present invention;

FIG. 3 is a flowchart of a method for reducing channel switching time in a receiver for a DMB satellite system in accordance with a preferred embodiment of the present invention; and

FIG. 4 illustrates channel switching time in a receiver for a DMB satellite system in accordance with a preferred embodiment of the present invention.

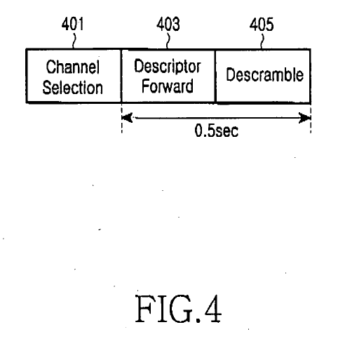

### DETAILED DESCRIPTION OF PREFERRED EMBODIMENTS

Preferred embodiments of the present invention will be described with reference to the accompanying drawings. In the following description, the same elements will be designated by the same reference numerals although they are shown in different drawings. Further, in the following description, only parts necessary for understanding the operations of the present invention will be described, and detailed description of known functions and configurations will be omitted for the sake of clarity.

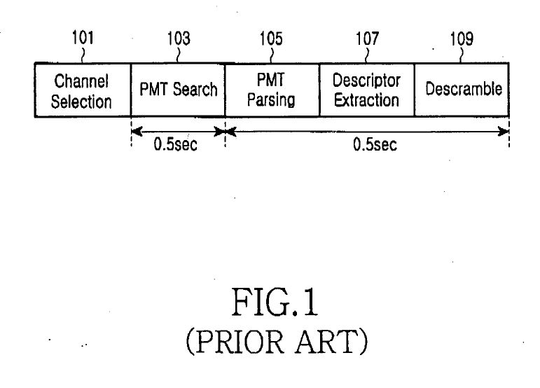

The basic concept of the present invention is to reduce channel switching time by providing a way to shortening the setup time of descriptor information as a parameter required for generating a CW when a receiver for a DMB satellite system receives a pay broadcast service. In general, the receiver searches for an ECM through a CAS of the DMB satellite system and, based on the searched ECM, generates a final CW value by communicating with a smart card provided therein, which occupies most of the time required for the descrambling process as described in FIG. 1. Further, a CA (Conditional Access) descriptor specifying the CAS exists in a PMT, and information required for actual descrambling, such as an ECM PID, can be extracted through the CA descriptor.

Therefore, the present invention provides a way to reduce channel switching time by storing the CA descriptor of a searched PMT in memory within the receiver when the receiver accesses a broadcast channel for the first time, and using the already stored CA descriptor of the corresponding PMT for descrambling in its entirety when the receiver subsequently accesses the same broadcast channel, so that a delay time of 0.5 second required for searching for the PMT, as described in FIG. 1, can be shortened.

As mentioned above, the CW required in descrambling can be detected through an EMM/ECM. The EMM is a viewing entitlement management message for determining whether or not a user has joined services of a broadcast provider, and the receiver can identify through the CA descriptor included in a CAT the PID of an EMM packet containing user information. The ECM is another viewing entitlement management message for determining whether or not the user has the authority to view each program selected, and the receiver can detect through the CA descriptor included in a PMT similar to that in the CAT the PID of an ECM packet necessary for calculating a CW value.

The configuration of a CA descriptor specifying the PID of an EMM/ECM packet in the CAS is given below in Table 3.

TABLE 3

| Data Structure | No. of Bits |
|---|---|
| local_time_offset_descriptor( ) { | |
| descriptor_tag | 8 |
| descriptor_length | 8 |
| CA_system_ID | 16 |
| reserved | 3 |
| CA_PID | 13 |
| for(i=0; i<N; i++){ | |
| private_data_type | 8 |
| } | |
| } | |

Using the CA descriptor extracted through the CAT/PMT, the PID of the EMM/ECM packet can be detected. A library of the CAS (hereafter CAS library) extracts data of the EMM/ECM packet through the CA descriptor, and forwards the extracted data to a smart card within the receiver. Then, using the EMM/ECM packet, the smart card extracts a final CW required in descrambling.

In general, the EMM is a common value given to all channels, and thus can be set up only by detecting it once. That is, the EMM has no influence on channel switching speed. However, since ECM has different values in a plurality of broadcast channels, PMT must be searched on a channel-by-channel basis. ECM cannot be used to prevent hacking, because as a stored value it is variable, but the value of PMT seldom changes.

Accordingly, the present invention provides a way to store in memory of a receiver the CA descriptor of the PMT, which has been used once, and reuse it when the receiver accesses the same channel next time.

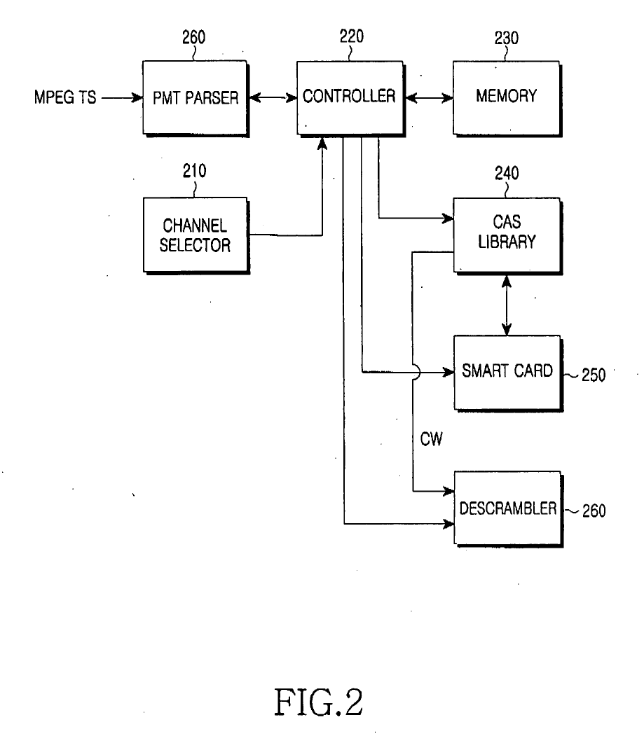

Referring to FIG. 2, if a user of a DMB satellite system selects a desired channel through a channel selector 210, a controller 220 checks if the CA descriptor of a PMT for a corresponding broadcast channel exists in a memory 230. Here, a Non-Volatile Random Access Memory (NVRAM), etc. may be used as memory 230. If the corresponding CA descriptor exists, controller 220 forwards the CA descriptor already stored in memory 230 to a CAS library 240 in its entirety, so that channel switching time can be reduced. CAS library 240 receives an ECM by using the forwarded CA descriptor, and then forwards the received ECM to a smart card 250. CAS library 240 carries out an interoperation with smart card 250 to generate a CW value for descrambling and deliver the generated CA value to a descrambler 260.

In addition, controller 220 reads out CA descriptor information from memory 230, and at the same time separately performs PMT search to compare the CA descriptor information stored in memory 230 with CA descriptor information in the current received PMT. If two pieces of information coincide with each other, controller 220 determines that the CA descriptor information read out from memory 230 and forwarded to CAS library 240 is valid, and thus does not perform any further operation. However, if the two pieces of information do not coincide with each other, controller 220 forwards the CA descriptor information obtained by the separate PMT search to CAS library 240, and at the same time updates the CA descriptor information in memory 230 with the new CA descriptor. Further, since the CA descriptor information previously stored in memory 230 is probably false, it is possible to simultaneously process a PMT parsing operation.

Table 4 presented below shows the configuration of the PMT. If the CA descriptor information of the PMT is extracted at channel access and the extracted CA descriptor information is forwarded to CAS library 240, the smart card within the receiver can generate a CW for descrambling.

TABLE 4

| Data Structure | No. of Bits | Bit String Expression |
|---|---|---|
| program_map_section( ) { | | |
| table_id | 8 | uimsbf |
| section_syntax_indicator | 1 | bslbf |
| “0” | 1 | bslbf |
| reserved | 2 | bslbf |
| section_length | 12 | uimsbf |
| program_number | 16 | uimsbf |
| reserved | 2 | bslbf |
| version_number | 5 | uimsbf |
| current_next_indicator | 1 | bslbf |
| section_number | 8 | uimsbf |
| last_section_number | 8 | uimsbf |
| reserved | 3 | |
| PCR_PID | 13 | uimsbf |
| reserved | 4 | bslbf |
| program_info_length | 12 | uimsbf |
| for(i=0; i<N; i++) { | | |
| descriptor( ) | | |
| } | | uimsbf |
| for(i=0; i<N; i++) { | | bslbf |
| stream_type | 8 | bslbf |
| reserved | 3 | bslbf |
| elementary_PID | 13 | uimsbf |
| reserved | 4 | |
| ES_info_length | 12 | |
| for(j=0; j<M; j++) | | |
| descriptor( ) | | rpchof |
| } | | |
| CRC_32 | 32 | |
| } | | |

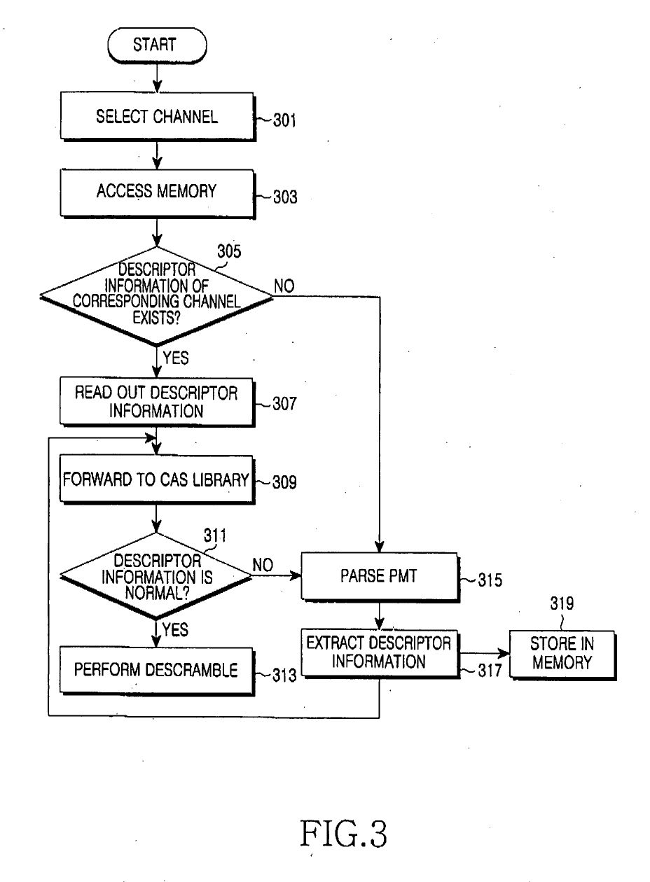

Referring to FIG. 3, first, if a user selects a desired broadcast channel in step 301, controller 220 senses this selection through channel selector 210. In step 303 controller 220 accesses memory 230 where the CA descriptor of a PMT according to the corresponding broadcast channel has been already stored. In step 305, controller 220 checks if the CA descriptor information of the corresponding broadcast channel exists in memory 230. If the CA descriptor exists, controller 220 proceeds to step 307, and reads out the corresponding CA descriptor form memory 230. Here, it is assumed that the corresponding CA descriptor of the PMT has been already stored in memory 230 at the previous access to the same broadcast channel.

Further, in step 309, controller 220 forwards the read-out CA descriptor to CAS library 240. When the CA descriptor forwarded to CAS library 240 in its entirety is determined in step 311 to be a normal descriptor, in step 313, CAS library 240 receives an ECM by using the CA descriptor information forwarded from controller 220, and forward the received ECM to smart card 250. The CAS library carries out an interoperation with smart card 250, having received the ECM, to generate a CW value for descrambling of the corresponding broadcast channel, and forwards the generated CW value to descrambler 260. If descrambler 260 receives the CW value, it descrambles data of the corresponding broadcast channel.

When the operations in steps 301 to 313 are performed normally, the CA descriptor, which has been already stored in the memory at the previous channel access, is forwarded intact to CAS library 240 without performing a PMT search for the corresponding broadcast channel, the PMT search process, which is conventionally performed as illustrated in step 103 of FIG. 1, can be omitted, and thus channel switching time can be reduced by a time of about 0.5 second.

On the contrary, if it has been proven in step 305 that the CA descriptor for the selected broadcast channel does not exist in memory 230, controller 220 conducts the PMT search as usual, and then proceeds to step 315. In step 315, controller 220 parses the PMT of the corresponding broadcast channel through a PMT parser 260, and then proceeds to step 317. In step 317, controller 220 extracts the corresponding CA descriptor, forwards the extracted CA descriptor to CAS library 240, and then proceeds to step 319. In step 319, controller 220 stores the corresponding CA descriptor in memory 230 so as to reuse it at a next entry into the same broadcast channel. In this case, the PMT search process is still carried out as usual when the receiver performs channel switching.

If a user selects a desired broadcast channel, as stated above, an application processor (not shown), which has already possessed channel information through EPG, forwards the PID of a PMT packet to controller 220. Then, controller 220 checks if the PID of the corresponding PMT packet is stored in memory 230. If a result of the checking shows that the PID is stored in memory 230, controller 220 extracts the corresponding CA descriptor information. However, if the PID is not stored in memory 230, controller 220 carries out the PMT search operation to extract CA descriptor information within the PMT, and then stores the extracted CA descriptor information in memory 230.

Meanwhile, if the existing channel schedule is changed to a new one, and the PID is that of a PMT packet corresponding to channel information which existed in the old channel schedule and now does not exist in the new channel schedule, the PID need not be stored in memory 230 any longer. In order to delete the PID of the PMT packet, which need not exist in memory 230 due to such channel reorganization, controller 220 carries out PAT search to retrieve the PID of each PMT packet within the PAT in advance. Then, controller 220 regards the PID of a PMT packet, which exists in memory 230 but does not in the PAT, as the PID of a PMT packet of a channel which does not exist any longer due to channel reorganization, and thus delete it so as to prevent unnecessary information from being stored in memory 230.

Further, in step 311, the CA descriptor forwarded intact to the CAS library 240 may be an abnormal descriptor. This is where the CA descriptor of the corresponding channel has existed in memory 230, but CAS library 240 cannot find data of a desired ECM packet because the PID of the ECM packet, etc. are changed at a transmitting end. In this case, controller 220 carries out PMT search, and proceeds to step 315. In step 315, controller 220 parses the PMT of the corresponding broadcast channel through the PMT parser 260, and then proceeds to step 317. In step 317, controller 220 extracts the corresponding CA descriptor, forwards the extracted CA descriptor to CAS library 240, and then proceeds to step 319. In step 319, controller 220 stores the corresponding CA descriptor in memory 230 so as to reuse it at next access to the same broadcast channel.

Since the CA descriptor information already stored in memory 230 may be false information (if so, the controller proceeds from step 311 to step 315), it may be preferred to simultaneously process the PMT parsing operation.

In the present invention, descriptor information of a corresponding PMT is stored in a memory within a receiver when the receiver accesses a broadcast channel, and then the descriptor information stored in the memory is used in its entirety without searching for the corresponding PMT again when the receiver accesses the same broadcast channel again. Thus, after a user selects a desired broadcast channel in step 401, descriptor information is forwarded intact to a CAS library in step 403, and descrambling is immediately performed in step 405 when the corresponding descriptor information of the selected broadcast channel is stored in the memory. As a result of this, the time required for performing PMT search and PMT parsing in the prior art can be shortened, which leads to accelerated channel switching speed.

Although the above-mentioned embodiments have been described by exemplifying the DMB satellite system using the CAS, they may also be applied to other multimedia broadcasting system capable of using the CAS.

According to the present invention as described above, in a multimedia broadcasting system when a broadcast channel is not changed using CAS, the corresponding CA descriptor information already stored in memory is forwarded directly to a CAS library at the channel access without a PMT search process, so that channel switching time can be reduced.

While the invention has been shown and described with reference to certain preferred embodiments thereof, it will be understood by those skilled in the art that various changes in form and details may be made therein without departing from the spirit and scope of the invention as further defined by the appended claims.

What is claimed is:

1. An apparatus for reducing channel switching time in a receiver for a Digital Multimedia Broadcasting (DMB) system, the apparatus comprising:
a Program Map Table (PMT) parser for parsing a searched PMT and extracting descriptor information of a corresponding broadcast channel;
a memory for storing the descriptor information according to each broadcast channel;
a Conditional Access System (CAS) library for generating a Control World (CW) value for descrambling by using the descriptor information; and
a controller for storing the descriptor information extracted for each broadcast channel in the memory, and accessing the memory to forward the descriptor information of a corresponding broadcast channel to the CAS library when a user selects the corresponding broadcast channel.

2. The apparatus of claim 1, wherein the controller simultaneously searches for the current PMT, and compare the stored descriptor information of the corresponding broadcast channel, with descriptor information of the currently searched PMT to check if the two pieces of descriptor information are equivalent.

3. The apparatus of claim 2, wherein the controller updates the stored descriptor information of the corresponding broadcast channel with the descriptor information of the currently searched PMT when the two pieces of descriptor information are not equivalent.

4. The apparatus of claim 1, wherein the controller further searches for the current PMT and update the descriptor information of the corresponding broadcast channel when the descriptor information read out from the memory is erroneous.

5. A method for reducing channel switching time in a receiver for a Digital Multimedia Broadcasting (DMB) system, the method comprising the steps of:
parsing a searched Program Map Table (PMT) and extracting descriptor information of a corresponding broadcast channel;
storing the descriptor information extracted for each broadcast channel in a memory;
accessing the memory to forward the descriptor information of a corresponding broadcast channel to a Conditional Access System (CAS) library when a user selects the corresponding broadcast channel; and
generating a Control Word (CW) value for descrambling of broadcast data by using the descriptor information.

6. The method of claim 5, further comprising searching simultaneously for the current PMT when reading out the descriptor information from the memory, and comparing the stored descriptor information of the corresponding broadcast channel with the descriptor information of the currently searched PMT to check if the two pieces of descriptor information are equivalent.

7. The method of claim 6, wherein searching for the current PMT and comparing the two pieces of descriptor information comprises updating the stored descriptor information of the corresponding broadcast channel with the descriptor information of the currently searched PMT when the two pieces of descriptor information are not equivalent.

8. The method of claim 5, further comprising searching for the current PMT and updating the descriptor information of the corresponding broadcast channel when the descriptor information read out from the memory is erroneous.

9. A receiver device for a Digital Multimedia Broadcasting (DMB) system using a Conditional Access System (CAS), the receiver device comprising:
a receiver for receiving broadcast channels over a wireless network;
a PMT parser for parsing a searched Program Map Table (PMT) and extracting descriptor information of a corresponding broadcast channel;
a memory for storing the descriptor information according to each broadcast channel;
a CAS library for generating a Control Word (CW) value for descrambling by using the descriptor information; and
a controller for storing the descriptor information extracted for each broadcast channel in the memory, and accessing the memory to forward the descriptor information of a corresponding broadcast channel to the CAS library when a user selects the corresponding broadcast channel.

10. The receiver device as claimed in claim 9, wherein the controller further simultaneously searches for the current PMT when reading out the descriptor information from the memory, and compare the stored descriptor information of the corresponding broadcast channel with descriptor information of the currently searched PMT to check if the two pieces of descriptor information are equivalent.

11. The receiver device of claim 10, wherein the controller updates the stored descriptor information of the corresponding broadcast channel with the descriptor information of the currently searched PMT when the two pieces of descriptor information are not equivalent.

12. The receiver device of claim 9, wherein the controller further searches for the current PMT and update the descriptor information of the corresponding broadcast channel when the descriptor information read out from the memory is erroneous.
